(19) United States
(12) Patent Application Publication
(10) Pub. No.: US 2010/0253196 A1
(43) Pub. Date: Oct. 7, 2010

(54) CABINET

(76) Inventor: S. Curtis Nye, Clinton, UT (US)

Correspondence Address: Workman Nydegger;1000 Eagle Gate Tower, 60 East South Temple, Salt Lake City, UT, 84111, US

(21) Appl. No.: 12/722,421

(22) Filed: Mar. 11, 2010

Related U.S. Application Data
(60) Provisional application No. 61/166,064, filed on Apr. 2, 2009.
(60) Provisional application No. 61/176,466, filed on May 7, 2009.

(51) Int. Cl. A47B 96/06; A47B 96/00; B23P 11/02

(52) U.S. Cl. 312/352; 248/224.8; 29/453

(57) ABSTRACT

A cabinet may include an upper wall, a lower wall and side walls. The cabinet may include a bracket that may be used to connect the cabinet to a mounting surface. The side walls may include receiving portions that receive portions of the bracket. The cabinet may also include one or more rear walls. The upper, lower, side and/or rear walls may include portions that overlap and/or engage with each other, which may help interconnect the walls and strength and/or reinforce the cabinet.

### CROSS-REFERENCE TO RELATED APPLICATIONS

This application claims priority to and the benefit of U.S. provisional patent application 61/166,064, filed Apr. 2, 2009 and entitled CABINET.

This application also claims priority to and the benefit of U.S. provisional patent application 61/176,466, filed May 7, 2009 and entitled CABINET.

The disclosures of each of these applications are hereby incorporated by reference in their entireties.

### BACKGROUND OF THE INVENTION

1. Field of the Invention

The present invention generally relates to enclosures and, in particular, to cabinets.

2. Description of Related Art

Conventional cabinets may be made from relatively heavy materials such as wood or metal. This may undesirably increase the weight of the cabinets and this may increase the cost of shipping the cabinets. In addition, the heavy weight may make the cabinets difficult and/or time-consuming to assemble.

### BRIEF SUMMARY OF EMBODIMENTS OF THE INVENTION

A need therefore exists for a cabinet that eliminates or diminishes the disadvantages and problems described above.

One aspect is a cabinet that may include one or more side walls, an upper wall and a lower wall. The cabinet may also include one or more shelves. The cabinet may further include one or more rear walls and one or more doors. The walls, shelves and doors may include engaging and/or overlapping portions, which may be sized and configured to engage and/or overlap with each other using, for example, a snap, friction and/or interference fit. Desirably, the engaging and/or overlapping portions may help interconnect the components of the cabinet. In addition, the engaging and/or overlapping portions may help strengthen and/or reinforce the cabinet and may help prevent the components of the cabinet from buckling. Moreover, the engaging and/or overlapping portions may also help prevent gaps from forming between the components of the cabinet.

A further aspect is the lower wall and the side walls may include one or more portions sized and configured to engage and/or overlap with each other. Significantly, if the engaging and/or overlapping portions of the lower and side walls engage each other, the side walls may advantageously help support the lower wall. For example, the side walls may include one or more projections that form ledges and the lower wall may include one or more portions that may rest upon the ledges, thus allowing the side walls to support the lower wall. In addition, the side walls may include one or more receiving portions that receive portions of the lower wall.

Another aspect is a cabinet that may include one more components constructed from plastic. For example, the cabinet may include one or more walls, shelves and/or doors that may be constructed from plastic using, for example, a molding process.

A further aspect is a cabinet that may include components constructed from blow-molded plastic. For example, the walls and/or shelves of the cabinet may be constructed from plastic using a blow-molding process. The blow-molded plastic walls and shelves may include a hollow interior portion, which may be integrally formed as part of a unitary, one-piece structure during the blow-molding process. The hollow interior portion may help the cabinet to be relatively lightweight and thus easier to move and less expensive to ship. The cabinet may also include one or more elongated reinforcing members, such as metal tubes or rods, which may strengthen and/or reinforce the walls and shelves. For example, one or more reinforcing members may be connected to and/or disposed within the walls and shelves to help strengthen and/or reinforce the walls and shelves. For instance, the side walls and/or the shelves may include receiving portions sized and configured receive a portion of one or more reinforcing members, which may extend between and/or be connected to the side walls. Desirably, when the reinforcing members extend between and/or are connected to the side walls, the reinforcing members may help strengthen, reinforce and/or support the lower wall.

Yet another aspect is a mounting device that may be sized and configured to mount a cabinet to a support surface, such as a wall or other support surface. The mounting device may include, for example, a bracket. The cabinet may include an upper wall, a lower wall, a first side wall, an opposing second side wall and a rear wall. The side walls may include one or more receiving portions sized and configured to receive and/or retain the bracket, which may extend between and/or be connected to the side walls. The bracket may include one or more spaced apart openings through which one or more fasteners may be inserted to connect the bracket, and thereby also the cabinet, to the wall or support surface. The bracket could, for example, including pairs of openings that are spaced apart between about 14 to 18 inches (for instance, about 16 inches), between about 22 to 26 inches (for instance, about 24 inches) or other distances that may allow the openings to be aligned with spaced apart wall studs to which the fasteners may be secured. The fasteners may extend through the openings in the bracket and also, if desired, the rear wall of the cabinet, but this is not required.

Still another further aspect is a mounting device for a cabinet. The mounting device and the cabinet may be constructed from different materials and/or may have different characteristics. For example, the mounting device may include a bracket that is constructed from metal and the walls of the cabinet may be constructed from plastic, such as blow-molded plastic. The walls and the bracket, however, may be constructed from the same or similar materials having the same or similar characteristics.

Another aspect is a cabinet that may include a shelf and one or more supports that may be sized and configured to support the shelf. The cabinet may also include walls that may include receiving portions that are sized and configured to receive and/or retain the supports. The receiving portions and supports may be connected using a snap, friction and/or interference fit. In further detail, one or more walls of the cabinet may include channels and the channels may include receiving portions disposed, for example, proximate the ends of the channels. The channels may also include ramps that may be sized and configured help guide the supports into these receiving portions. For instance, a support may have an elongated configuration that extends from a first end to a second end. The first end of the support may be inserted into a first receiving portion in a channel of a first side wall. With the first end of the support inserted into the first receiving portion, the second end of the support may be inserted into a channel of an opposing second side wall. The second end of the support may then be moved up a ramp in the channel of the second side wall and snapped into a receiving portion in the channel of the second side wall. This may advantageously secure the support using a snap, friction and/or interference fit. Thus, the channel and/or the ramp may help to guide the support into a snap, friction and/or interference fit with the walls of the cabinet.

Yet another aspect is one or more cabinets may be aligned. For example, the cabinets may include one or more alignment members and that may allow a plurality of cabinets to be aligned. In greater detail, the exterior surfaces of the side walls, floor and/or upper walls of the cabinets may include alignment members, such as complementary projections and/or receiving portions, that help to align adjacent cabinets. In particular, the receiving portions of one cabinet may be sized and configured to receive the projections of an adjacent cabinet to help align the cabinets. This may help in arranging the cabinets in various suitable configurations such as side-to-side and/or stacked upon each other. The aligned cabinets may also be connected using one or more fasteners (such as screws or bolts), adhesives and the like. If desired, the cabinets or portions of the cabinets may be at least substantially interchangeable to allow them to form part of a modular system.

Still another aspect is a storage structure that may include a first side panel constructed from blow-molded plastic, which may include a hollow interior portion and a first receiving portion integrally formed during a blow-molding process. The storage structure may also include a second side panel constructed from blow-molded plastic, which may include a hollow interior portion and a first receiving portion integrally formed during a blow-molding process. The storage structure may also include an upper panel constructed from blow-molded plastic, which may be connected to the first and second blow-molded plastic side panels and may include a hollow interior portion integrally formed during a blow-molding process. The storage structure may also include a lower panel constructed from blow-molded plastic, which may be connected to the first and second blow-molded plastic side panels and may include a hollow interior portion integrally formed during a blow-molding process. The storage structure may also include an elongated metal mounting bracket including a first end disposed within the first receiving portion of the first blow-molded plastic side panel, a second end disposed within the first receiving portion of the second blow-molded plastic side panel, a first opening sized and configured to receive a first fastener secure the storage structure to a mounting surface, and a second opening sized and configured to receive a second fastener secure the storage structure to a mounting surface.

Another aspect is a storage structure that may include an upper panel constructed from blow-molded plastic that may include a hollow interior portion integrally formed during a blow-molding process. The storage structure may also include a lower panel constructed from blow-molded plastic including a hollow interior portion, a first side and an opposing second side integrally formed during a blow-molding process. The storage structure may also include a first side panel constructed from blow-molded plastic, which may be connected to the upper and lower blow-molded plastic panels and may include a hollow interior portion and at least one projection integrally formed during a blow-molding process. The at least one projection of the first blow-molded plastic side panel may be disposed underneath and may support the first side of the blow-molded plastic lower panel. The storage structure may also include a second side panel constructed from blow-molded plastic, which may be connected to the upper and lower blow-molded plastic panels and may include a hollow interior portion and at least one projection integrally formed during a blow-molding process. The at least one projection of the second blow-molded plastic side panel may be disposed underneath and may support the second side of the blow-molded plastic lower panel.

Yet another aspect is a method for using a storage structure including a first side panel and a second side panel. The method may include inserting a first end of a first elongated member into a first receiving portion of the first side panel; snapping an opposing second end of the first elongated member into a first receiving portion of the second side panel; and placing a shelf onto the first elongated member such that the first elongated member supports at least a portion of the shelf.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a perspective view of an exemplary cabinet;

FIG. 2 is a perspective view of the cabinet shown in FIG. 1, illustrating doors of the cabinet opened;

FIG. 3 is an exploded view of the cabinet shown in FIG. 1;

FIG. 4 is an enlarged view of a portion of the cabinet shown in FIG. 3, illustrating rear walls;

FIG. 5 is an enlarged view of a portion of the cabinet shown in FIG. 3, illustrating a lower wall;

FIG. 6 is an enlarged view of a portion of the lower wall shown in FIG. 5;

FIG. 7 is an perspective view of a portion of the cabinet shown in FIG. 3, illustrating a side wall;

FIG. 8 is an enlarged view of a portion of the side wall shown in FIG. 7;

FIG. 9 is a perspective view of a portion of the cabinet shown in FIG. 3, illustrating another side wall;

FIG. 10 is an enlarged view of a portion of a rear wall shown in FIG. 4;

FIG. 11 is an enlarged view of a portion of the side wall shown in FIG. 9;

FIG. 12 is a perspective view of a portion of the cabinet shown in FIG. 3, illustrating an upper wall;

FIG. 13 is a perspective view of a portion of the cabinet shown in FIG. 3, illustrating a bracket;

FIG. 14 is a side view of the bracket shown in FIG. 13;

FIG. 15 is a perspective view of a portion of an embodiment of the side panel shown in FIG. 9, illustrating ramps, channels and receiving portions; and

FIG. 16 is a perspective view of a portion of an embodiment of the side panel shown in FIG. 7, illustrating ramps, channels and receiving portions.

### DETAILED DESCRIPTION OF THE PREFERRED EMBODIMENTS

The present invention is generally directed towards a cabinet. The principles of the present invention, however, are not limited to cabinets. It will be understood that, in light of the present disclosure, the cabinet disclosed herein can be successfully used in connection with other types of structures, shelves, bookcases, enclosures, etc.

Additionally, to assist in the description of the cabinet, words such as top, bottom, front, rear, right and left may be used to describe the accompanying figures, which are not necessarily drawn to scale. It will be appreciated, however, that the cabinet can be located in a variety of desired positions and/or orientations. A detailed description of the cabinet now follows.

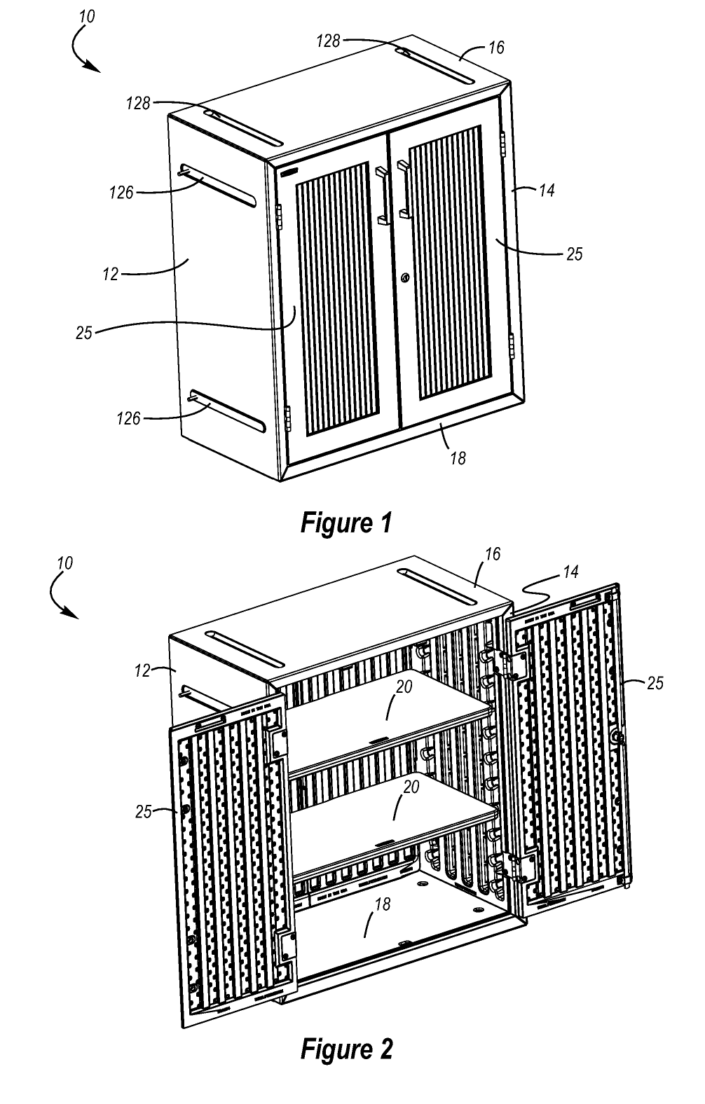

A cabinet 10 shown in FIGS. 1-2 may be used to store and/or enclose a variety of items. As shown in FIGS. 1-3, the cabinet 10 may include one or more side walls 12, 14, an upper wall 16 and a lower wall 18. The cabinet 10 may also include one or more shelves 20. The cabinet 10 may further include one or more rear walls 22, 24 and one or more doors 25.

The doors 25 may be movably connected to the side walls 12, 14 using, for example, one or more hinges, connectors or the like. It will be appreciated, however, that the doors 25 are not required.

The walls 12, 14, 16, 18, 22, 24; shelves 20; doors 25 and/or other components of the cabinet may be constructed from plastic panels using a blow-molding process. The blow-molded plastic components may include spaced apart surfaces and a hollow interior portion at least partially disposed between the surfaces, which may be integrally formed as part of a unitary, one-piece component during the blow-molding process. The hollow interior portion may help the cabinet 10 to be relatively lightweight and thus easier to move and less expensive to ship. It will be appreciated, however, that the walls, shelves, doors and/or other components of the cabinet 10 may be constructed from plastic, wood, metal and/or other suitable materials using other molding and/or manufacturing processes.

The cabinet 10 may include one or more elongated supports or reinforcing members 26, 28, 30. The elongated supports 26, 28, 30 may be sized and configured to strengthen and/or reinforce the cabinet 10, in particular, by strengthening and/or reinforcing one or more of the walls 12, 14, 16, 18, 22, 24; shelves 20 and doors 25. For example, to strengthen and/or reinforce the walls, shelves and/or doors, the elongated supports 26, 28, 30 may be connected to and/or disposed within one or more of the walls, shelves and/or doors.

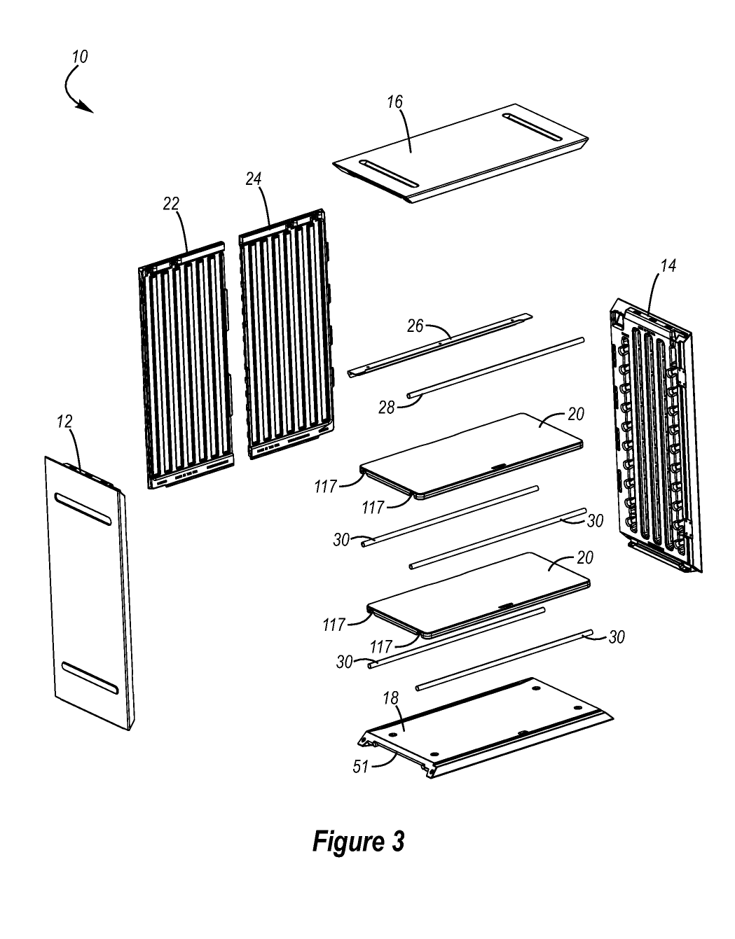

The elongated supports 26, 28, 30 may be constructed from metal which may advantageously help significantly strengthen and/or reinforce the walls 12, 14, 16, 18, 22, 24; shelves 20 and doors 25, for example, when the walls are constructed from plastic. The elongated support 26 may, for instance, be constructed from sheet metal and the elongated supports 28, 30 may be constructed from metal tubes or rods. As shown in FIG. 3, the elongated metal supports 26, 28, 30 may be arranged in a generally horizontal direction. If desired, the elongated supports 26, 28, 30 may be sufficiently strong such that elongated generally vertical metal supports are not required. Thus, in some embodiments, the cabinet 10 may be free from any elongated generally vertical metal supports, which may help reduce manufacturing costs and/or reduce the overall weight of the cabinet. It will be appreciated, however, that the elongated supports 26, 28, 30 may be positioned, horizontally, vertically or in any other orientation. It will also be appreciated that the elongated supports 26, 28, 30 need not be constructed from metal and that the elongated supports 26, 28, 30 may be constructed from wood, metal, plastic and/or other suitable materials.

The walls 12, 14, 16, 18, 22, 24; shelves 20 and doors 25 may include engaging and/or overlapping portions. The engaging and/or overlapping portions may include projections, receiving portions and/or other features that may be sized and configured to engage, overlap and/or interlock with each other using, for example, a snap, friction and/or interference fit. Desirably, the engaging and/or overlapping portions may help interconnect the walls. In addition, the engaging and/or overlapping portions may help strengthen and/or reinforce the cabinet 10 and may help prevent the walls 12, 14, 16, 18, 22, 24; shelves 20 and doors 25 from buckling. Moreover, the engaging and/or overlapping portions may also help prevent gaps from forming between the walls 12, 14, 16, 18, 22, 24; shelves 20 and doors 25. In addition to the engaging and/or overlapping portions, the cabinet 10 may include one or more fasteners that may be used to interconnect any of the adjacent walls 12, 14, 16, 18, 22, 24; shelves 20 and doors 25. Exemplary engaging and/or overlapping members are discussed in further detail below.

As shown in FIG. 4, the rear walls 22, 24 may include portions that may be sized and configured to engage and/or overlap with each other. For example, the rear walls 22, 24 may include projections 32, 34, 36 may be sized and configured to engage, overlap with and/or be received by receiving portions 38, 40, 42, respectively. This may advantageously help interconnect the rear walls 22, 24 and/or help secure the rear walls in a desired relative position.

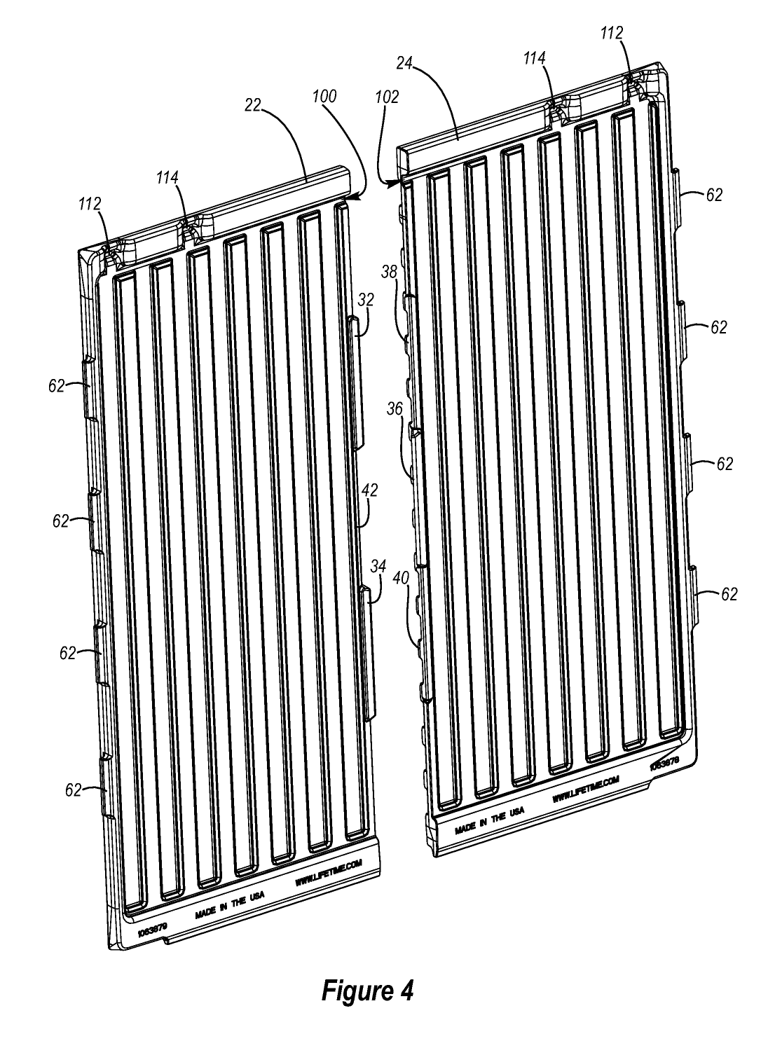

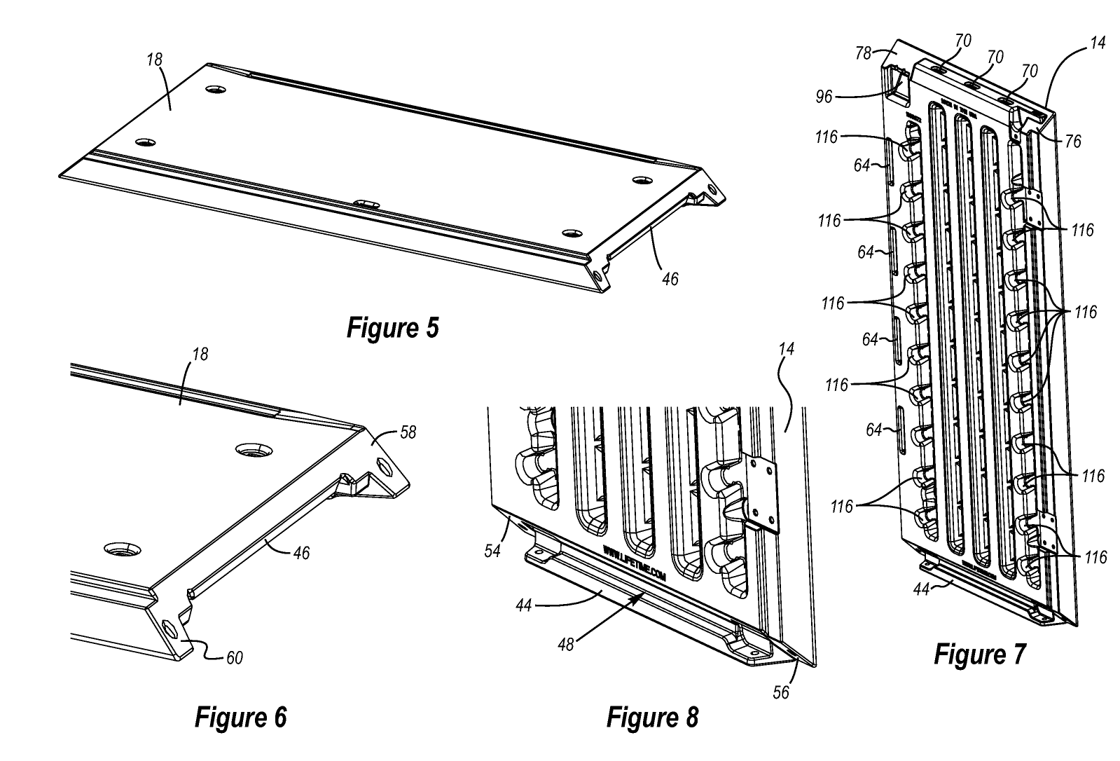

As shown in FIGS. 5-8, a side wall and the lower wall 18 may include portions that may be sized and configured to engage and/or overlap with each other. For example, the side wall 14 may include one or more projections or elongated ledges 44 that may contact, abut and/or engage a side, edge or lip 46 of the lower wall 18. For example, the lower wall's side, edge or lip 46 may overlap with and/or rest upon the side wall's projection or ledge 44 to allow the side wall to help support the lower wall. Thus, the projection or elongated ledge 44 may be disposed underneath the side, edge or lip 46 of the lower wall 18. In addition, the side wall 14 may include a receiving portion 48 that may be sized and configured to receive and/or retain at least a portion of the lower wall's side, edge or lip 46.

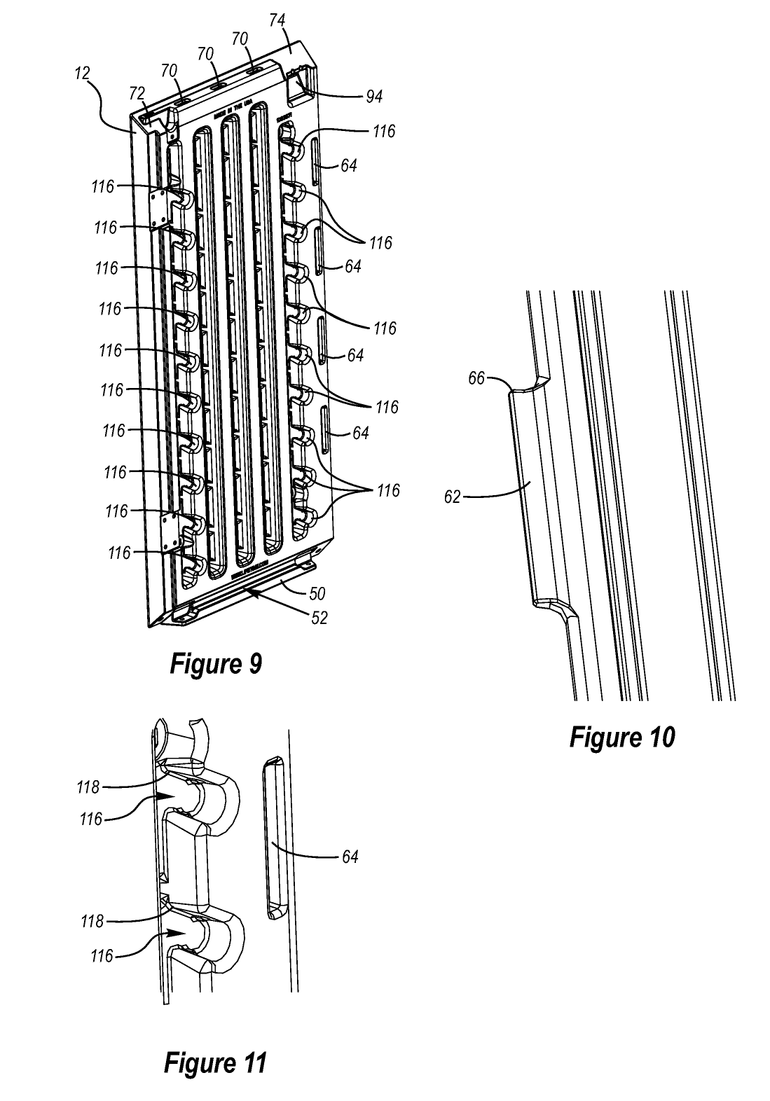

The side wall 12 may also include one or more projections or elongated ledges 50 shown in FIG. 9, upon which an opposing second side, edge or lip 51 of the lower wall 18 shown in FIG. 3 may rest to help further support the lower wall. Thus, the projection or elongated ledge 50 may be disposed underneath the side, edge or lip 51 of the lower wall 18. In addition, the side wall 12 may include a receiving portion 52, which may be sized and configured to receive and/or retain at least a portion of the side, edge or lip 51 of the lower wall 18.

The side walls 12, 14 and the lower wall 18 may include portions, which may engage and/or overlap with each other to form a mitered look shown in FIG. 1. For example, as shown in FIGS. 6 and 8, the side wall 14 may include sloped or angled portions 54, 56 that may contact, abut and/or overlap with complementary sloped or angled portions 58, 60 of the lower wall 18 to form the mitered look. The side wall 12 may also include sloped or angled portions that may contact, abut and/or overlap with complementary sloped or angled portions of the lower wall 18 to form the mitered look.

The side walls 12, 14 and the rear walls 22, 24 may include portions that may be sized and configured to engage and/or overlap with each other. In particular, the rear walls 22, 24 may include elongated projections 62 shown in FIG. 4 that may be sized and configured to engage, overlap with and/or be received by elongated receiving portions 64 (for instance, slots) of the side walls 12, 14 shown in FIGS. 7 and 9. As shown in FIG. 10, the projections 62 may include an upwardly oriented portion 66, which may form a hook or the like, that may engage and/or by received by an upwardly oriented recess of a receiving portion 64 to secure the rear walls 22, 24 to the side walls 12, 14. Desirably, the side and rear walls 12, 14, 22, 24 may advantageously include multiple projections 62 and receiving portions to help spread out forces along their lengths.

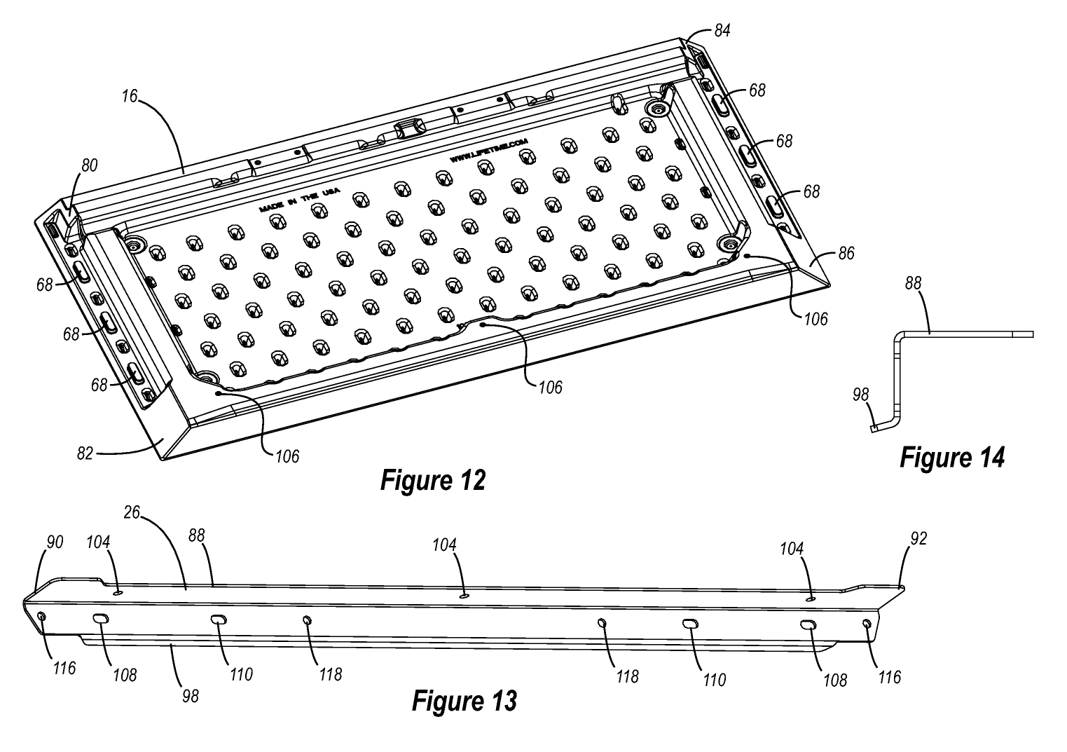

The side walls 12, 14 and the upper wall 16 may include portions that may be sized and configured to engage and/or overlap with each other. For example, the upper wall 16 may include projections 68 shown in FIG. 12 that may engage, overlap with and/or be received by receiving portions 70 of the side walls 12, 14 shown in FIGS. 7 and 9. In addition, the side walls 12,14 may include sloped or angled portions 72, 74, 76, 78 that may contact, abut and/or overlap with complementary sloped or angled portions 80, 82, 84, 86 of the upper wall 16 to form a mitered look.

As shown in FIG. 13, the support 26 may comprise a mounting bracket 88. Desirably, the mounting bracket 88 may be used to connect the cabinet 10 to a mounting structure, such as a wall. In particular, one or more portions of the mounting bracket 88 may be inserted into receiving portions of one or more of the walls 12, 14, 16, 20, 22, 24. Desirably, if portions of the mounting bracket 88 are inserted into receiving portions of the walls 12, 14, 16, 20, 22, 24, then the mounting bracket may help better support the cabinet when connected to the wall or support surface. The mounting bracket 88 may also include openings sized and configured to receive fasteners to connect the bracket to the wall or support surface and/or portions of the cabinet 10.

In further detail, the mounting bracket 88 may have an elongated configuration extending between end portions 90, 92. The end portions 90, 92 of the mounting bracket 88 may be disposed within receiving portions 94, 96 in the side walls 12, 14. The mounting bracket 88 may also include a generally rearward extending projection or lip 98 and at least a portion of the projection or lip may be disposed within receiving portions 100, 102 in the rear walls 22, 24.

The mounting bracket 88 may include one or more openings 104 that may abut and/or be aligned with portions 106 formed in the upper wall 16, and the fasteners may be inserted into the bracket's openings to interconnect the mounting bracket and the upper wall. The portions 106 of the upper wall 16 may include openings and/or fastener bosses that may receive and/or retain at least a portion of the fasteners inserted through the mounting bracket's openings 104.

The mounting bracket 88 may also include one or more openings 108, 110 that may be aligned with portions 112, 114 formed in the rear walls 22, 24, and the fasteners may be inserted into the bracket's openings to connect the mounting bracket and the rear walls to the wall or support surface. The portions 112, 114 of the rear walls 22, 24 may include recesses and/or openings that may receive and/or retain at least a portion of the fasteners that inserted through the openings 108, 110 in the mounting bracket 88.

The openings 108 in the mounting bracket 88 may be spaced apart at a first distance and the openings 110 in the mounting bracket 88 may be spaced apart at a smaller second distance. In particular, the openings 108 may be spaced apart about 24 inches and the openings 110 may be spaced apart about 16 inches, which may allow the openings to be aligned with wall studs. In addition, the openings 110 may be spaced apart between about 14 to 18 inches, and the openings 108 may be spaced apart between about 22 to 26 inches, which may allow the openings to be aligned with wall studs. After the openings 108 or the openings 110 are aligned with the wall studs, fasteners may be inserted through the openings, the portions 112, 114 formed in the rear walls 22, 24, and into the wall studs to secure the cabinet 10 to the wall studs. It will be appreciated, however, that the openings 108, 110 may be spaced apart at greater or lesser distances and that the openings need not be aligned with wall studs.

The mounting bracket 88 may also include one or more openings 116 that may receive fasteners to connect the mounting bracket to the side walls 12, 14 and/or a mounting surface, and one or more openings 118 that may receive fasteners to connect the mounting bracket to the rear walls 22, 24 and/or a mounting surface.

As shown in FIG. 3, the cabinet 10 may include the supports 30. The supports 30 may extend between and/or be connected to the side walls 12, 14. In particular, the side walls 12, 14 may include receiving portions that may be sized and configured to receive and/or retain a portion of the supports 30 using, for instance, a snap, friction and/or interference fit. A shelf 20 may contact, abut, engage and/or rest upon a pair of the supports 30, which may allow the supports 30 to strengthen, reinforce and/or support the shelf. The shelves 30 may include receiving portions 117 shown in FIG. 3 sized and configured to receive and/or retain a portion of the supports 30 using, for instance, a snap, friction and/or interference fit.

In one example, as shown in FIGS. 7, 9 and 11, the receiving portion 116 may include an opening 118 in a side wall of the receiving portion. Accordingly, a first end of a support 30 may be inserted into a receiving portion 116 of a first side wall 12, 14 via an opening 118 in the side wall, and a second end of the support 30 may be inserted into a receiving portion 116 of a second side wall 12, 14 via an opening 118 in the side wall. The receiving portions 116 may receive and/or retain the ends of the supports 30 using, for example, a snap, friction and/or interference fit. In addition, the opening 118 may be oriented upward to allow the shelves 20 and items placed on the shelves to exert a downward force on the supports 30, which may further help retain the ends of the supports 30 in the receiving portions 116.

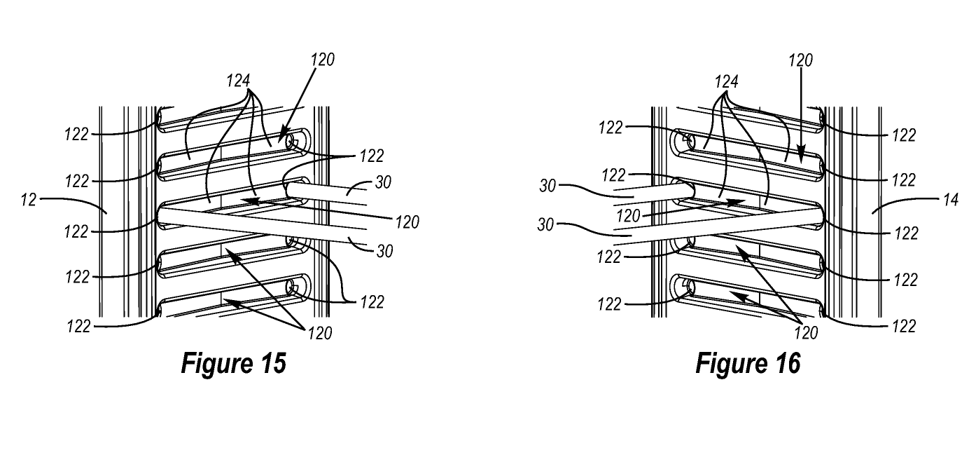

In another example, as shown in FIGS. 15 and 16, the side walls 12, 14 could include channels 120 and the channels may include receiving portions 122 disposed, for example, proximate the ends of the channels. The channels 120 may also include ramps 124 that may be sized and configured help guide the supports into the receiving portions 122. A first end of a support 30 may be inserted into a first receiving portion 122 in a channel 120 of a first side wall 12, 14. With the first end of the support 30 inserted into the first receiving portion 122, a second end of the support 30 may be inserted into a channel 120 of a second side wall 12, 14. The second end of the support 30 may then be moved up and along a ramp 124 in the channel 120 of the second side wall 12, 14 until the second end of the support snaps into a second receiving portion 122 in the channel of the second side wall. This may advantageously secure the support using a snap, friction and/or interference fit. Thus, the channel 120 and/or the ramp 124 may help to guide the support 30 into a snap, friction and/or interference fit with the side walls 12, 14 of the cabinet 10.

As shown in FIG. 1, the cabinet 10 may include one or more alignment members that may allow a plurality of the cabinets to be aligned. In greater detail, the exterior surfaces of the side walls 12, 14; upper wall 16, and/or lower wall 18 of the cabinets 10 may include alignment members 126, 128, such as complementary projections and/or receiving portions, that help to align adjacent cabinets. In particular, the receiving portions of one cabinet 10 may be sized and configured to receive the projections of an adjacent cabinet 10 to help align the cabinets. This may help in arranging the cabinets 10 in various suitable configurations such as side-to-side and/or stacked upon each other. The aligned cabinets 10 may also be connected using one or more fasteners (such as screws or bolts), adhesives and the like. If desired, the cabinets or portions of the cabinets may be at least substantially interchangeable to allow them to form part of a modular system.

In some embodiments, the cabinet 10 may include an upper wall 16 that may be detachable. The cabinet 10 may also include one or more feet or wheels, which may be detachable also. Advantageously, the feet and/or wheels may allow the cabinet 10 to be more versatile. For example, without the wheels, the cabinet 10 may rest on a floor, but with the wheels, the cabinet 10 may be easily rolled along the floor. In addition, without the wheels or feet and/or without the upper wall, the cabinet 10 may be mounted on a wall or other type of support surface.

In some embodiments, the cabinet 10 may include a rear portion, which may be ornamental or decorative. For example, the rear portion may include one or more patterns, which may be repeated. This may advantageously allow one or more of the cabinets 10 to be used as a room divider.

As mentioned above, the walls 12, 14, 16, 18, 22, 24; shelves 20; doors 25 and/or other components may be constructed from plastic. Significantly, the features of a plastic component may be integrally formed as part of a unitary, one-piece component during a molding process. For example, the projections 32, 34, 36, 62; the receiving portions 38, 40, 42, 48, 52, 64, 70, 94, 96, 100, 102; the projections or ledges 44, 50; the edge or lip 46; the sloped or angled portions 54, 56, 58, 60, 72, 74, 76, 78, 80, 82, 84, 86; alignment members 126, 128 and/or other features may be integrally formed in the walls 12, 14, 16, 18, 22, 24; shelves 20 and doors 25 during the molding process.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A storage structure comprising:
a first side panel constructed from blow-molded plastic, the first blow-molded plastic side panel including a hollow interior portion and a first receiving portion integrally formed during a blow-molding process;
a second side panel constructed from blow-molded plastic, the second blow-molded plastic side panel including a hollow interior portion and a first receiving portion integrally formed during a blow-molding process;
an upper panel constructed from blow-molded plastic, the blow-molded plastic upper panel connected to the first and second blow-molded plastic side panels, the blow-molded plastic upper panel including a hollow interior portion integrally formed during a blow-molding process;
a lower panel constructed from blow-molded plastic, the blow-molded plastic lower panel connected to the first and second blow-molded plastic side panels, the blow-molded plastic lower panel including a hollow interior portion integrally formed during a blow-molding process; and
an elongated metal mounting bracket including:
a first end disposed within the first receiving portion of the first blow-molded plastic side panel;
a second end disposed within the first receiving portion of the second blow-molded plastic side panel;
a first opening sized and configured to receive a first fastener secure the storage structure to a mounting surface; and
a second opening sized and configured to receive a second fastener secure the storage structure to a mounting surface.

2. The storage structure as in claim 1, wherein the mounting surface includes a pair of spaced apart wall studs; and wherein the first and second openings of the elongated metal mounting brackets are spaced apart about sixteen (16) inches to facilitate connection of the elongated metal mounting bracket to the pair of spaced apart wall studs.

3. The storage structure as in claim 1, wherein the mounting surface includes a pair of spaced apart wall studs; and wherein the first and second openings of the elongated metal mounting brackets are spaced apart between about fourteen (14) to eighteen (18) inches to facilitate connection of the elongated metal mounting bracket to the pair of spaced apart wall studs.

4. The storage structure as in claim 1, wherein the mounting surface includes a pair of spaced apart wall studs; and wherein the first and second openings of the elongated metal mounting brackets are spaced apart about twenty four (24) inches to facilitate connection of the elongated metal mounting bracket to the pair of spaced apart wall studs.

5. The storage structure as in claim 1, wherein the mounting surface includes a pair of spaced apart wall studs; and wherein the first and second openings of the elongated metal mounting brackets are spaced apart between about twenty two (22) to twenty six (26) inches to facilitate connection of the elongated metal mounting bracket to the pair of spaced apart wall studs.

6. The storage structure as in claim 1, further comprising:
a first rear panel constructed from blow-molded plastic, the first blow-molded plastic rear panel including a hollow interior portion and a projection integrally formed during a blow-molding process; and
a second rear panel constructed from blow-molded plastic, the second blow-molded plastic rear panel including a hollow interior portion and a projection integrally formed during a blow-molding process;
wherein the first blow-molded plastic side panel further includes a second receiving portion integrally formed during a blow-molding process, the projection of the first rear panel interlocking with the second receiving portion of the first blow-molded plastic side panel; and
wherein the second blow-molded plastic side panel further includes a second receiving portion integrally formed during a blow-molding process, the projection of the second rear panel interlocking with the second receiving portion of the second blow-molded plastic side panel.

7. The storage structure as in claim 6, wherein the first opening of the elongated metal mounting bracket is aligned with a portion of the first blow-molded plastic rear panel to allow the first fastener to extend through the first blow-molded plastic rear panel and the first opening of the elongated metal mounting bracket to secure the storage structure to the mounting surface; and
wherein the second opening of the elongated metal mounting bracket is aligned with a portion of the second blow-molded plastic rear panel to allow the second fastener to extend through the second blow-molded plastic rear panel and the second opening of the elongated metal mounting bracket to secure the storage structure to the mounting surface.

8. The storage structure as in claim 7, wherein the elongated metal mounting bracket further includes:
a third opening aligned with a portion of the first blow-molded plastic side panel to allow a third fastener to extend through the first blow-molded plastic side panel and the third opening to interconnect the first blow-molded plastic side panel and the elongated metal mounting bracket; and
a fourth opening aligned with a portion of the first blow-molded plastic side panel to allow a third fastener to extend through the first blow-molded plastic side panel and the third opening to interconnect the first blow-molded plastic side panel and the elongated metal mounting bracket.

9. The storage structure as in claim 1, wherein the first blow-molded plastic side panel further includes an elongated ledge disposed underneath and supporting a first edge of the blow-molded plastic lower panel; and
wherein the second blow-molded plastic side panel further includes an elongated ledge disposed underneath and supporting a opposing second edge of the blow-molded plastic lower panel.

10. The storage structure as in claim 1, further comprising:
a metal tube connected to the first and second blow-molded plastic side panels, the metal tube including a first end and an opposing second end; and
a shelf at least partially supported by the metal tube;
wherein the first blow-molded plastic side panel further includes a second receiving portion that receives and retains the first end of the metal tube; and
wherein the second blow-molded plastic side panel further includes a second receiving portion that receives and retains the second end of the metal tube using a snap, friction and/or interference fit.

11. The storage structure as in claim 10, wherein the second blow-molded plastic side panel further includes:
a channel, the second receiving portion of the second blow-molded plastic side panel being disposed within the channel; and
a ramp disposed within the channel;
wherein the channel and ramp are sized and configured guide the metal tube into the snap, friction and/or interference fit with the second receiving portion of the second blow-molded plastic side panel.

12. A storage structure comprising:
an upper panel constructed from blow-molded plastic including a hollow interior portion integrally formed during a blow-molding process;
a lower panel constructed from blow-molded plastic including a hollow interior portion, a first side and an opposing second side integrally formed during a blow-molding process;
a first side panel constructed from blow-molded plastic, the first blow-molded plastic side panel connected to the upper and lower blow-molded plastic panels, the first blow-molded plastic side panel including a hollow interior portion and at least one projection integrally formed during a blow-molding process, the at least one projection of the first blow-molded plastic side panel disposed underneath and supporting the first side of the blow-molded plastic lower panel; and
a second side panel constructed from blow-molded plastic, the second blow-molded plastic side panel connected to the upper and lower blow-molded plastic panels, the second blow-molded plastic side panel including a hollow interior portion and at least one projection integrally formed during a blow-molding process, the at least one projection of the second blow-molded plastic side panel disposed underneath and supporting the second side of the blow-molded plastic lower panel.

13. The storage structure as in claim 12, wherein the at least one projection of the first blow-molded plastic side panel includes an elongated ledge disposed underneath and supporting the first side of the blow-molded plastic lower panel; and
wherein the at least one projection of the second blow-molded plastic side panel includes a second elongated ledge disposed underneath and supporting the second side of the blow-molded plastic lower panel.

14. The storage structure as in claim 12, further comprising:
an elongated member connected to the first and second blow-molded plastic side panels, the elongated member including a first end and an opposing second end;
a shelf at least partially supported by the elongated member;
wherein the first blow-molded plastic side panel further includes a receiving portion that receives and retains the first end of the elongated member; and
wherein the second blow-molded plastic side panel further includes a receiving portion that receives and retains the second end of the elongated member.

15. The storage structure as in claim 14, wherein the second blow-molded plastic side panel further includes:
a channel, the receiving portion of the second blow-molded plastic side panel being disposed within the channel; and
a ramp disposed within the channel;
wherein the channel and ramp are sized and configured guide the elongated member into the snap, friction and/or interference fit with the receiving portion of the second blow-molded plastic side panel.

16. A method for using a storage structure including a first side panel and a second side panel, the method comprising:
inserting a first end of a first elongated member into a first receiving portion of the first side panel;
snapping an opposing second end of the first elongated member into a first receiving portion of the second side panel; and
placing a shelf onto the first elongated member such that the first elongated member supports at least a portion of the shelf

17. The method as in claim 16, wherein the second side panel further includes:
a channel, the first receiving portion of the second side panel being disposed within the channel; and
a ramp disposed within the channel;
wherein snapping an opposing second end of the first elongated member into a first receiving portion of the second side panel comprises:
inserting the second end of the first elongated member into the channel; and
moving the second end of the first elongated member along the ramp until the second end of the first elongated member snaps into the first receiving portion of the second side panel.

18. The method as in claim 16, further comprising:
inserting a first end of a second elongated member into a second receiving portion of the first side panel;
snapping an opposing second end of the second elongated member into a second receiving portion of the second blow-molded plastic side panel; and
placing the shelf onto the second elongated member such that the first elongated member supports at least a portion of the shelf and the second elongated member supports at least a portion of the shelf

19. The method as in claim 16, further comprising:
inserting a first end of a second elongated member into a second receiving portion of the second side panel;
snapping an opposing second end of the second elongated member into a second receiving portion of the first blow-molded plastic side panel; and
placing the shelf onto the second elongated member such that the first elongated member supports at least a portion of the shelf and the second elongated member supports at least a portion of the shelf

20. The method as in claim 16, wherein the first side panel is constructed from blow-molded plastic; and wherein the first and second receiving portions of the first blow-molded plastic side panel are integrally formed during a blow-molding process;
wherein the second side panel is constructed from blow-molded plastic; and wherein the first and second receiving portions of the second blow-molded plastic side panel are integrally formed during a blow-molding process;
wherein the first elongated member is constructed from metal; and
wherein the second elongated member is constructed from metal.
